(19) United States
(12) Patent Application Publication
(10) Pub. No.: US 2005/0284967 A1
(43) Pub. Date: Dec. 29, 2005

(54) Showerhead

(76) Inventors: Yaakov Korb, Elyria, OH (US); Lonnie Fulton Cool, North Olmsted, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/875,703

(22) Filed: Jun. 24, 2004

(51) Int. Cl. B05B 1/14

(52) U.S. Cl. 239/552; 239/600; 239/556; 239/558

(57) ABSTRACT

A showerhead includes a base connected with a water supply assembly. The base has a front wall with a plurality of water outlets; a plurality of waterways for directing water from the water supply assembly to the water outlets; and a plurality of cavities between the waterways that are not pressurized with water when the showerhead is operated. The showerhead may optionally include a front cover releasably supported on the base, and having a plurality of openings through which water from the water outlets of the base flows. If so, the front cover may be decorative and not pressurized with water when the showerhead is operated. A non-adjustable showerhead includes a structural unit having waterways that limit the surface area of the structural unit that is exposed to water pressure thereby limiting the force on the structural unit. The front wall of the structural unit may be exposed and serve not only a structural function but also as the esthetic part of the showerhead.

### BACKGROUND OF THE INVENTION

1. Technical Field

The present invention relates to a non-adjustable showerhead that distributes water from a large area of the showerhead front surface. A showerhead of this type is sometimes referred to as a “rain shower”.

2. Description of the Prior Art

In a typical non-adjustable prior art showerhead, a front cover or shell has an inner side surface that partially defines a pressurized water chamber in the showerhead. Water is admitted into the water chamber through the shower arm. Water that flows into the water chamber contacts all areas of the inner side surface of the front cover. As a result, the entire front cover is pressurized, and thus a relatively large amount of force is placed on the front cover. As one example, U.S. Pat. No. 3,713,587 shows a typical showerhead in which a chamber extending the entire width or area of the showerhead cover is filled with pressurized water.

A typical multi-function (adjustable) prior art showerhead has a front cover with several different groups or areas of water outlets for providing several alternative functions—a massage function, a spray function, etc. The showerhead also has internal channels for selectively directing water, under the control of a valve, to one or the other outlet areas of the shell These channels direct flow of water at any one time to only the selected outlet areas of the face plate. The showerhead is not operable to direct flow of water all of the outlet areas of the face plate at the same time.

As one example, U.S. Pat. No. 5,476,225 discloses a typical adjustable showerhead having concentric rings of spray openings connected by circular channels. Water sprays out through orifices that receive their water from a large pressurized chamber above them that extends for substantially the entire width of the showerhead. Because that chamber extends for substantially the entire width of the showerhead, there is a large amount of axially directed force on the showerhead.

U.S. Pat. No. 4,427,155 is directed to an adjustable, selectable showerhead. It includes a circular base having small openings that are arranged in wedge shaped patterns. Water is directed axially through the openings to form spray patterns. The entire upper surface area of the plate that forms the wedge-shaped patterns is exposed to the incoming water pressure.

U.S. Pat. No. 4,364,523 discloses an adjustable showerhead having wedge-shaped notches that direct water into selected spray openings connected by circular channels. A flexible seal closes more or less of the flow area of the notches to control flow rate in response to varying inlet water pressure.

U.S. Pat. No. 6,557,785 discloses a “venturi” showerhead in which water shoots radially outward from the center along channels best seen in FIGS. 4 and 5, to make spray jets of aerated water. No internal pressure is built within the head because it has no cover. Water sprays out through orifice. The orifices receive their water from a chamber above them that is pressurized with water and that extends over areas other than the orifices, for a large portion of the overall width of the showerhead. Because that chamber extends for substantially the entire width of the showerhead, there is a large amount of axially directed force on the showerhead.

### SUMMARY OF THE INVENTION

The present invention relates in one aspect to a showerhead including a water supply assembly, and a base connected with the water supply assembly. The base has a front wall with a plurality of water outlets; a plurality of waterways for directing water from the water supply assembly to the water outlets; and a plurality of cavities between the waterways that are not pressurized with water when the showerhead is operated. The showerhead also includes a front cover releasably supported on the base, and having a plurality of openings through which water from the water outlets of the base flows. The front cover is not pressurized with water when the showerhead is operated.

The present invention also relates to a showerhead having a plurality of waterways that contain water when the showerhead is pressurized and having a plurality of cavities between the waterways that do not contain water when the showerhead is pressurized thereby to limit the surface area of the showerhead that is exposed to water pressure. Preferably the showerhead does not have a full width water chamber.

In another aspect, a showerhead includes a structural unit having waterways that limit the surface area of the structural unit that is exposed to water pressure thereby limiting the force on the structural unit. The showerhead also includes a front cover that carries substantially no water pressure.

### DETAILED DESCRIPTION OF THE INVENTION

The showerhead 10 includes a water supply assembly 12. The water supply assembly 12 for a showerhead 10 of the present invention may take differing forms. The water supply assembly 12 serves the functions of physically connecting the showerhead to the shower arm, and directing water from the shower arm into the showerhead. In the illustrated embodiment, the water supply assembly 12 includes a hollow internally threaded ball 14 that can be screwed onto a shower arm or hose (not shown). The ball 14 is pivotable relative to (within) the other portions of the showerhead 10, to enable the showerhead to be positioned as desired by the user. The illustrated water supply assembly 12 also includes a spring 16 to load the parts of the showerhead 10 during assembly and to maintain the selected pivotal orientation of the showerhead relative to the shower arm.

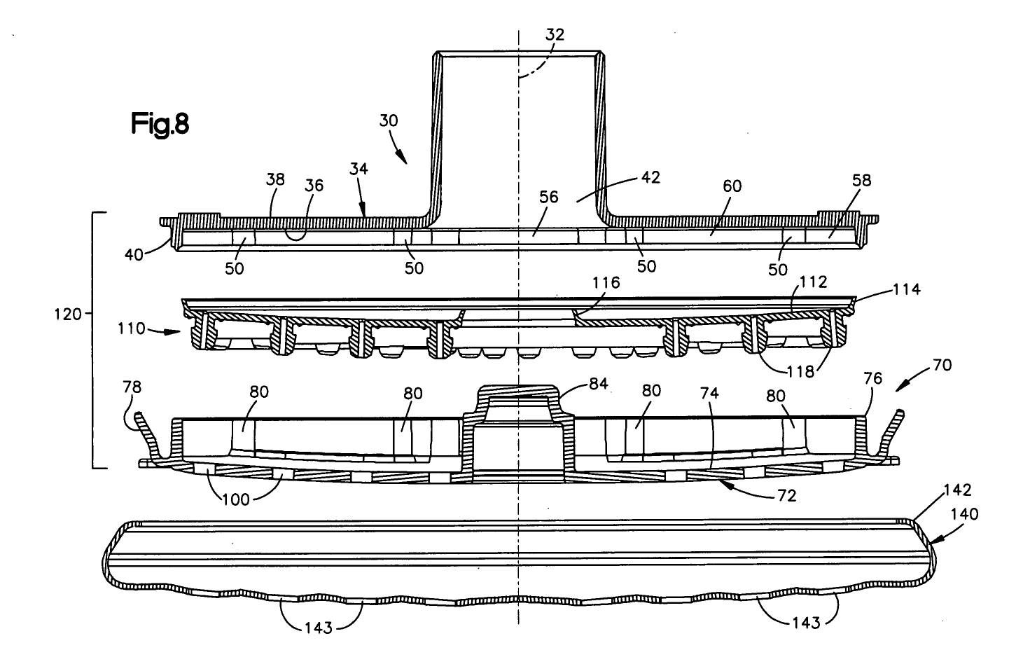

The showerhead 10 also includes a base 20. The base 20 is a structural unit within the showerhead 10 and includes a back plate 30, a front plate 70, and an insert 110 the base 20 is preferably made from plastic but could be made from a different material. The back plate 30 has (FIGS. 5 and 8) a generally circular configuration centered on an axis 32. The back plate 30 includes a generally planar back wall 34 with circular inner and outer major side surfaces 36 and 38. The back wall 34 is circumscribed by an annular, outer peripheral rim 40 that projects axially outward from the inner side surface 36. The back wall 34 has a central opening 42 centered on the axis 32. A hollow hub 44 of the back plate 30 extends axially from the back wall 34. The hub 44 communicates with the central opening 42 in the back wall 34 and is adapted to engage the water supply assembly 12 to direct water from the water supply assembly to the base 30.

The back wall 34 of the back plate 20 is interrupted at spaced locations by a plurality of axially projecting wall halves 50 (FIG. 5). Each one of the wall halves 50 has a generally triangular configuration including two radial side wall portions 52 that are substantially the same length as each other, as well as an arcuate end wall portion 54 joining the outer ends of the side wall portions.

In the illustrated embodiment, ten identical wall halves 50 are provided on the back plate 20, spaced apart equally in a circular array centered on the axis 32. The wall halves 50 have the same axial extent (height) as the outer rim 40 of the back plate 30. The triangular space within each one of the wall halves is empty—that is, the back wall 34 of the back plate 30 is discontinuous (not present) at those locations.

The wall halves 50 of the back plate 30 define a plurality of passages. Specifically, a central chamber portion 56 is defined in the back plate 30, radially inward of the triangular wall halves 50, and centered on the axis 32. Between the outer rim 40 and the end wall portions 54 of the triangular wall halves 50 there is defined an annular, outer passage 58. A plurality of radial passages 60 extend radially between the central chamber portion 56 and the outer passage 58. The radial passages 60 extend between, and are located between, adjacent wall halves 50 of the back plate 30.

The back wall 34 of the back plate 30, as thus divided or broken up by the wall halves 50, includes a circular wall section 62 that overlies the central chamber portion; ten generally rectangular radial wall sections 64 that overlie the radial passages 60; and an annular wall section 66 that overlies the outer passage 58. Because of the presence of the wall halves 50, the surface area of the back wall 34 (including the circular wall section 62, the rectangular wall sections 64, and the outer wall section 66) is significantly less than the overall area that is circumscribed by the outer rim 40 of the back plate 30. The difference is substantially equal to the sum of the individual areas of the triangular wall halves 50.

The front plate 70 is similar in configuration to the back plate 30. The front plate 70 has a generally circular configuration centered on the axis 32 and includes a generally planar front wall 72 with an inner side surface 74. The front wall 72 is circumscribed by an annular, outer peripheral rim 76 that projects axially from the inner side surface 74. The rim 76 of the front plate 70 has the same diameter as the rim 40 of the back plate 30. A plurality of snaps 78 are formed on the outside of the front plate 70.

The front wall 72 is interrupted at spaced locations by a plurality of axially projecting wall halves 80. The wall halves 80 of the front plate 70 are similar in number, configuration and placement to the wall halves 50 of the back plate 30. Each one of the wall halves 80 on the front plate 70 has a generally triangular configuration including two radial side wall portions 82 that are substantially the same length as each other and an arcuate end wall portion 84 joining the outer ends of the side wall portions.

In the illustrated embodiment, ten identical wall halves 80 are provided, spaced apart equally in a circular array centered on the axis 32. The wall halves 80 have the same axial extent (height) as the outer rim 76 of the front plate 70. The triangular space within each one of the wall halves 80 is empty—that is, the front wall 72 of the front plate 70 is discontinuous (not present) at those locations.

The wall halves 80 of the front plate 70 define a plurality of passages which, together with corresponding passages of the back plate 30, form waterways (described below) in the showerhead 10. Specifically, the wall halves 80 of the front plat 70 define a central chamber portion 82 in the front plate 70, radially inward of the wall halves 80 and centered on the axis 32. An annular, outer passage 86 is defined between the rim 76 and the end wall portions 84 of the triangular wall halves 80. A plurality of radial passages 88 extend radially between the central chamber portion 82 and the outer passage 86 portion. The radial passages 88 extend between, and are located between, adjacent wall halves 80 of the front plate 70.

The front plate 70 has a central hub 84 that extends inward from the front wall 72. The hub 84 is smaller in diameter than the central opening 42 in the back plate 30.

The front wall 72 of the front plate 70, as thus divided or broken up by the wall halves 80, thus includes a circular wall section 90 that overlies the central chamber portion 82; ten generally radial wall sections 92 that overlie the radial passages 88; and an annular wall section 94 that overlies the outer passage portion 86. Because of the presence of the wall halves 80, the surface area of the front wall 72 (including the circular wall section 90, the radial wall sections 92, and the outer wall section 94) is significantly less than the overall area that is circumscribed by the outer rim 76 of the front plate 70. The difference is equal to the sum of the individual areas of the triangular wall halves 80.

The front wall 72 of the front plate 70 has a plurality of outlet openings 100 for enabling water to flow out of the showerhead 10. Some of the openings 100 are located in the circular wall section 90. Others of the openings 100 are located in the radial wall sections 92, and still others of the openings 100 are located in the outer wall section 94. Because the area of the front wall 72 of the front plate 70 is limited or reduced as described above, the outlet openings 100 are therefore located on only a limited portion of the overall area that is circumscribed by the outer rim 74 of the front plate.

The insert 110 is assembled to the front plate 70 during assembly of the showerhead, before the front plate is secured to the back plate 30. The insert 110 is made from an elastomeric material such as rubber or synthetic rubber or plastic. The insert 110 has a generally planar main body portion 112 with a circular configuration. The main body portion 112 is adapted to overlie the inner side surface 74 of the front wall 72 of the front plate 70.

The insert 110 has an cylindrical outer peripheral rim 114 that projects inward from the main body portion 112, along the rim 76 of the front plate 70. The rim 114 of the insert 110 seals against the rim 76 of the front plate 70. The insert 110 also has a plurality of lips 116 that project inward from the main body portion 112, along the wall halves 80 of the front plate 70. The lips 116 of the insert 110 seal against the wall halves 80 of the front plate 70.

The insert 110 further includes a plurality of nubs 118 that extend axially outward from the main body portion 112. The nubs 118 extend through the outlet openings 100 in the front wall 72 of the front plate 70. The elastomeric material of which the nozzles 118 are made seals the outlet openings 100 in the front plate 70. Each one of the nubs 118 forms a nozzle, that is, has an opening extending axially through it.

The front plate 70 is connected with the back plate 30, and including the insert 110, to form the base 20 of the showerhead 10. The connection of the front plate 70 with the back plate 30 can be made in different ways. In the preferred embodiment, the plates 70 and 30 are joined together by hot plate welding. The plates 70 and 30 could, alternatively, be joined together by sonic welding, or glue or another adhesive, for example.

When the two plates 70 and 30 are thus joined together to form the base 20, the outer rim 76 of the front plate 70 is secured and sealed to the outer rim 40 of the back plate 30. The end wall portions 84 of the triangular wall halves 80 of the front plate 70 are secured and sealed to the end wall portions 54 of the triangular wall halves 50 of the back plate 30. The side wall portions 82 of the triangular wall halves 80 of the front plate 70 are secured and sealed to the side wall portions 52 of the triangular wall halves 50 of the back plate 30.

This connection of the front plate 70 with the back plate 30 has three effects. First, a seal is formed between the front plate 70 and the back plate 30. Second, movement of the front plate 70 away from the back plate 30 is blocked. And third, a water chamber 122 is formed in the base.

The water chamber 122 includes a central waterway 124 that is made up of the central chamber portion 56 of the back plate 30 and the central chamber portion 82 of the front plate 70. The water chamber 122 also includes an annular outer waterway 126 that is made up of the outer passage 58 of the back plate 30 and the outer passage 86 of the front plate 70. The water chamber 122 also includes a plurality of radial waterways 130 that are made up of the radial passages 60 of the back plate 30 and the radial passages 88 of the front plate 70. The radial waterways 130 extend between and interconnect the central waterway 124 and the outer waterway 126.

The term “waterway” as used herein is broad and thus can include a generally discrete volume such as the waterways numbered 124, 126 and 130 as described above. It can also include an entire volume that is filled with water, for example, a single spiral chamber that does not have particularly discrete parts; and can also include a portion of a single volume or of a more discrete volume. The term “waterway portion” thus refers to volume that is intentionally pressurized with water when the showerhead is pressurized, and can refer to a discrete or non-discrete portion (up to all) of a waterway, and thus can include up to an entire waterway or water chamber.

Because the front plate 70 is sealed to the back plate 30, the water chamber 122 is an enclosed, sealed chamber in the base 20. The only openings for water to flow into or out of the water chamber 122 are (a) through the hub of the back plate 44, and (b) through the nozzles 118 in the insert, which extend through the outlet openings 100 in the front plate 70.

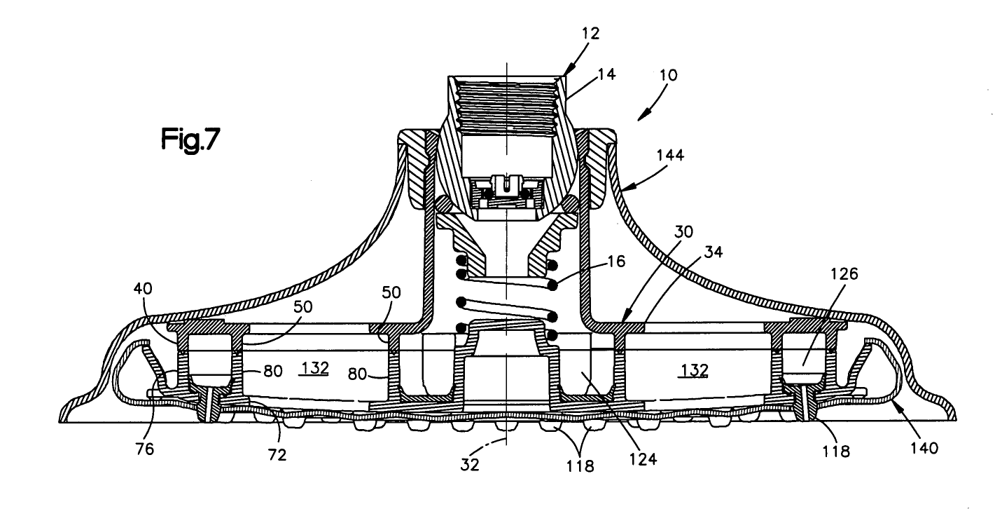

When the base 20 is thus formed by joining the front plate 70 to the back plate 30, a plurality of open spaces or cavities 132 (FIG. 7) are present between the radial waterways 130. In the illustrated embodiment, the cavities 132 have a triangular configuration.

The cavities 132 are not part of the water chamber 122 and are not exposed to water pressure when the showerhead is pressurized. The term “cavity” is used herein to refer to a volume of space within the envelope of a showerhead that has certain qualities. Specifically, a cavity is not occupied by water when the showerhead is pressurized. Also, a cavity has walls on its front and back around its entire perimeter.

The cavities 132 extend completely through (in an axial direction) the base 20. The cavities have front walls which are part of the front cover 140. The cavities 132 have back walls which are parts of the back cover 144.

The parts of the showerhead 10 may be assembled as follows. The insert 110 is assembled to the front plate 70 as described above. When this is done, the nozzles 118 on the insert 110 project through the outlet openings 100 in the front wall 72 of the front plate 70. The front plate 70 and the back plate 30 are then welded (or otherwise secured together, as described above) to form the base 20. The base 20 is assembled to the water supply assembly 12.

A front cover 140 of the showerhead 10 is then snapped on. The front cover 140 has a rim 142 that extends around and engages the snaps (78) on the front plate 70. When this is done, the nozzles 118 on the insert 110 project through openings 143 in the front cover 140. A back cover 144 of the showerhead 10 is then assembled, and a retainer ring 146 is pressed in to secure the parts. The cover 140 could alternatively be attached with screws, or any other way of attachment, if desired.

When water under pressure is supplied to the showerhead 10, the water flows into the showerhead through the water supply assembly 12 and into the central chamber waterway 124 of the base 20. The water flows out of the central waterway 124, through the radial waterways 130, and into the outer waterway 126, filling the entire water chamber 122 simultaneously with water under pressure.

The water thus flows into the showerhead 10 axially, into the relatively small area of the central chamber waterway 124. The water then flows radially or laterally from the central chamber waterway 124 into the radial waterways 130.

The water flows out of the showerhead 10 through the nozzles 118. Specifically, some water flows out of the showerhead through the nozzles 118 that are located on the front wall section 90 overlying the central waterway 124. Some water flows out of the showerhead 10 through the nozzles 118 that are located on the front wall sections 92 overlying the radial waterways 130. Other water flows out of the showerhead 10 through the nozzles 118 that are located on the annular front wall section 94 overlying the outer waterway 126. The water flows out of all the nozzles 118 simultaneously, because the entire water chamber 122 is pressurized whenever the showerhead 10 is in use.

As noted above, however, the outlet openings 100 in the front plate 70 are located on only a limited portion of the overall area that is circumscribed by the outer rim 74 of the front plate. As a result, water flows out of only a limited portion of the overall area of the showerhead 10. No water flows or is present in the cavities 132 between the radial waterways 130. The water that flows out of the nozzles of the showerhead 10 forms an overall spray envelope of the showerhead in which the spray of water from the shower occurs. In this embodiment, the overall spray envelope is in the shape of a circle. Spray envelopes can be in any shape, however. The outer waterway 126 thus extends around the outer periphery of the spray envelope of the showerhead.

When the showerhead 10 is thus pressurized, the various walls of the base 20 channel and direct the flow of water within the base only, so that the water does not contact the front cover 140. There is no water pressure on the front cover 140.

Because there is no water force on the front cover 140, the front cover is decorative and not structural. The front cover 140 therefore can be mounted on the showerhead 10 with only the snaps 78 (or in any other suitable manner). No gluing or clamping is needed, and no central screw is needed, as is often the case in the prior art. As a result, the showerhead 10 can have a better visual design as the structural requirements are decreased. In addition, the base can be used as a modular insert for many visually different showerheads. All of the different showerheads could have the same waterways, but different shells (front and back covers). In addition, the base can be used alone without a front cover or a back cover.

Because of the limited surface area of the front wall 72 of the base 70 that is exposed to pressurized water, the amount of force on the front wall, arising from that water pressure, is reduced as compared to the amount of force that would be present on a circular front wall having the same diameter but being pressurized over the entire circular area. Channeling the water flow into the waterways 124, 126 and 130 thus reduces the amount of force on the front wall 72 (and on the back wall 34) of the base 20.

For example, a typical prior art rain shower showerhead may have 45 water outlet openings with a diameter of 0.047 inches each. The total area of a four inch diameter showerhead, not including the combined area of the outlet openings, is about 12.5 square inches. This entire area is exposed to the pressure of the water in the showerhead. Since force equals pressure times area, then with a pressure of 20 psi, the force on the showerhead is about 250 pounds. Similarly, for a six inch showerhead, the force is about 560 pounds, and for an eight inch showerhead, the force is about 1,000 pounds.

A 4 inch diameter showerhead in accordance with the present invention may still have 45 water outlet openings with a diameter of 0.047 inches each. However, the total area of the front plate that is exposed to the pressure of the water in the showerhead, not including the combined area of the outlet openings, is only about 3.89 square inches. Since force equals pressure times area, then with a pressure of 20 psi, the force on the front plate is about only 77.8 pounds—substantially less than in the prior art showerhead. Similarly, for a 6 inch showerhead, the force is only about 100 pounds, and for an 8 inch showerhead, the force is about only 140 pounds. Furthermore, the same spray envelope as the prior art showerheads can be maintained even with this reduction in force.

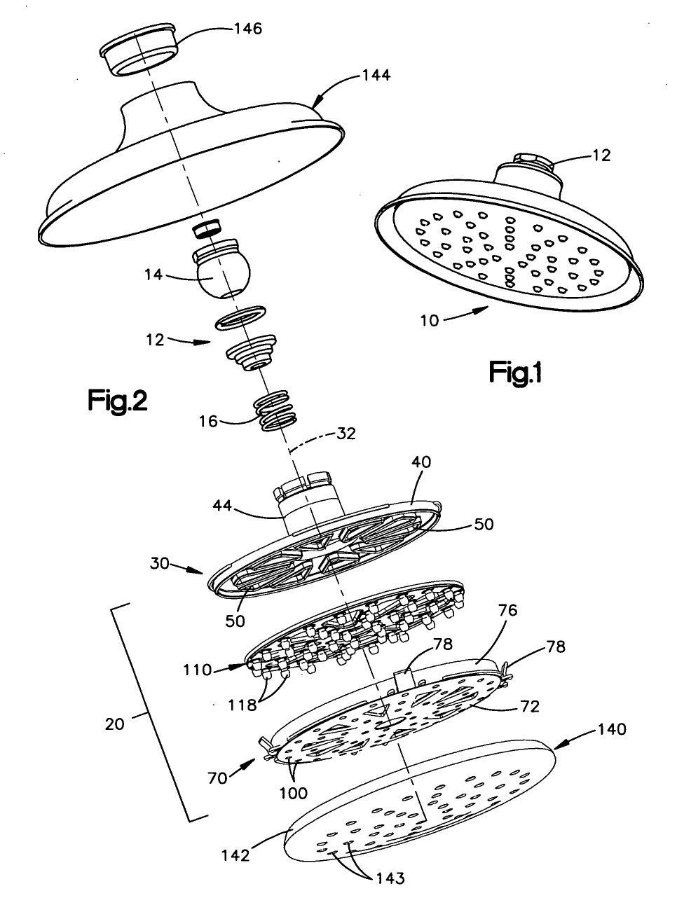

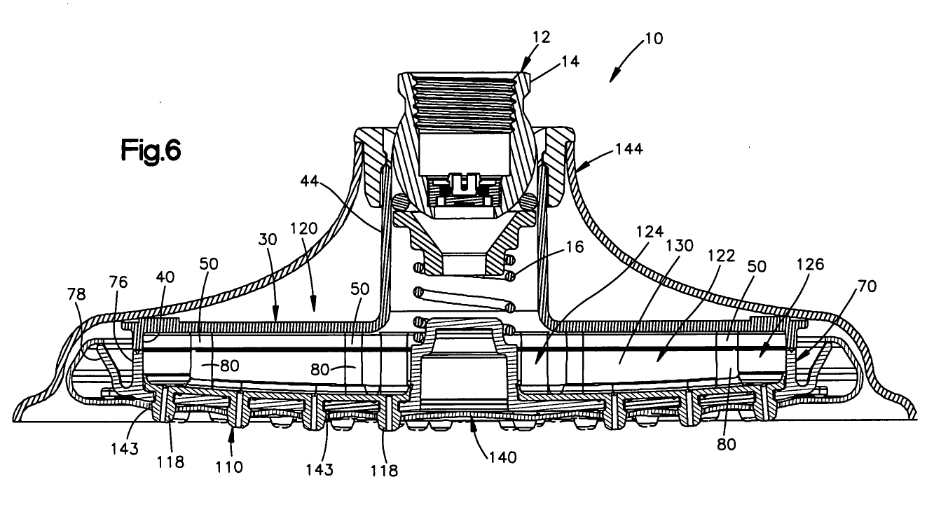

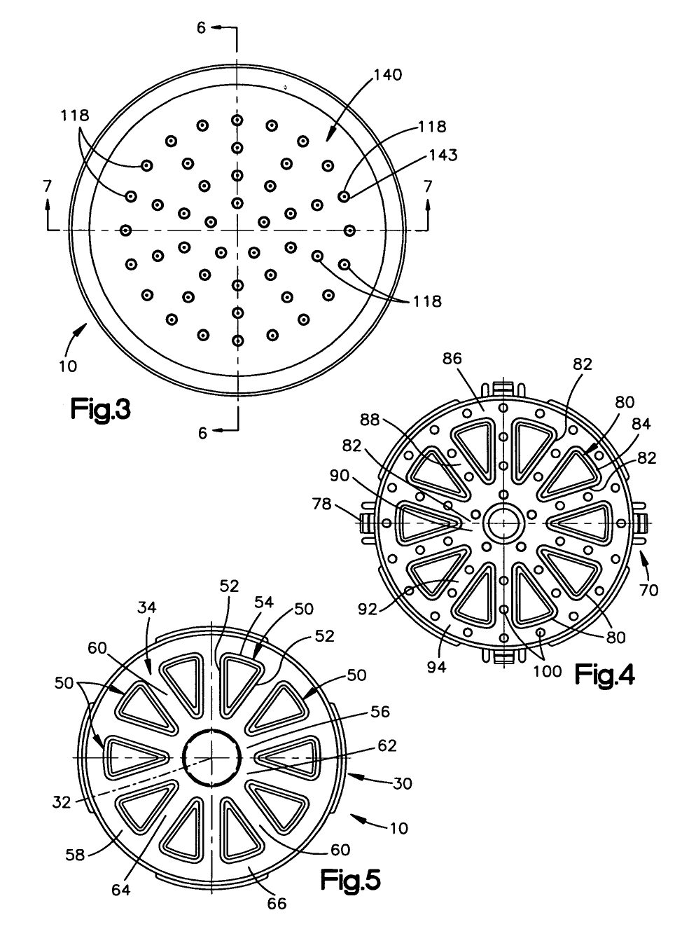

The total area of the front plate 70 of the showerhead 10 that is illustrated in FIGS. 1-8 is about 31% of the total area of the front cover of the prior art showerhead—substantially less than in the prior art showerhead. Showerheads in accordance with the invention can provide a reduction in force on the front or outer (and possibly on the back or outer) surface or cover, a reduction in the range of from below about 10% up to about 90% or more.

In addition, the fastening and sealing requirements between the various parts of the showerhead 10, including the base 20, the back cover 144, and the front cover 140, are less rigorous, which can mean less development cost and lower part cost. Also, the substantial reduction in force can make it feasible to manufacture showerheads 10 of relatively large sizes, for example, eight to twelve inches or more in diameter.

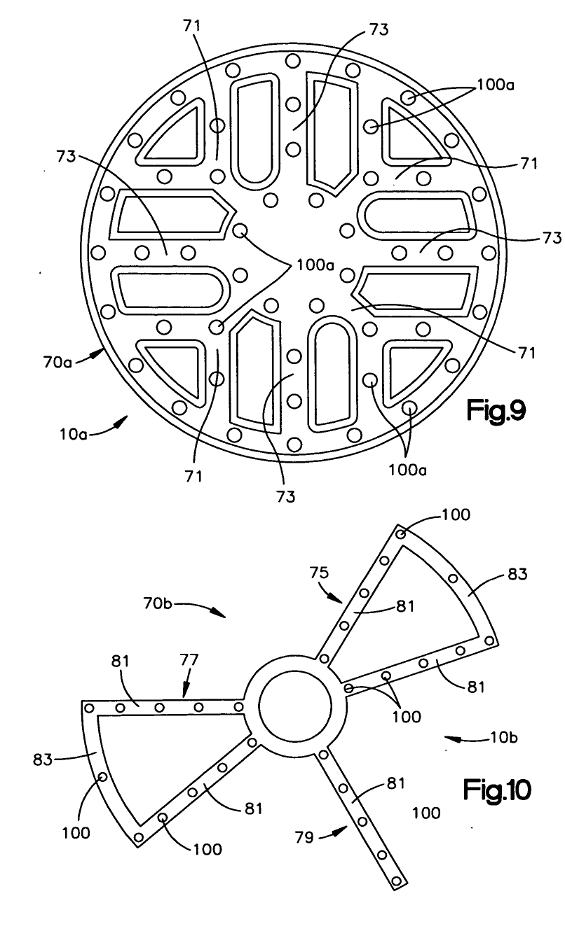

FIG. 9 is an illustration of a portion of a circular showerhead 10a that is another embodiment of the invention. Specifically, FIG. 9 is a plan view of a different front plate 70a having a different waterway configuration. (The showerhead 10a also includes a back plate, not shown, that cooperates with the front plate 70a to form a base.) The front plate 70a shown in FIG. 9 includes wall portions that define four Y-shaped passages 71 separated by radial passages 73. The front plate 70a has outlet openings 100a communicating with the passages 71 and 73, and not in other areas of the front plate. This is but one example of the many different waterway configurations that can be provided in a circular showerhead.

FIG. 10 is an illustration of a portion of a non-circular showerhead 10b that is another embodiment of the invention. Specifically, FIG. 10b is a plan view of a different front plate 70b having a different waterway configuration. The showerhead 10b possesses a three-armed overall configuration with two wider arms 75 and 77 and a narrower third arm 79. (The showerhead 10b also includes a back plate, not shown, that cooperates with the front plate 70b to form a base.) The front plate 70b shown in FIG. 9 includes wall portions that define five radial passages 81 and two arcuate outer peripheral passages 83. The front plate 70b has outlet openings 100b communicating with the passages 81 and 83, and not in other areas of the front plate. This is but one example of the many different waterway configurations that can be provided in a non-circular showerhead. Other examples include a sunflower design, a spiral design, a pinwheel design, or any one of many other shapes.

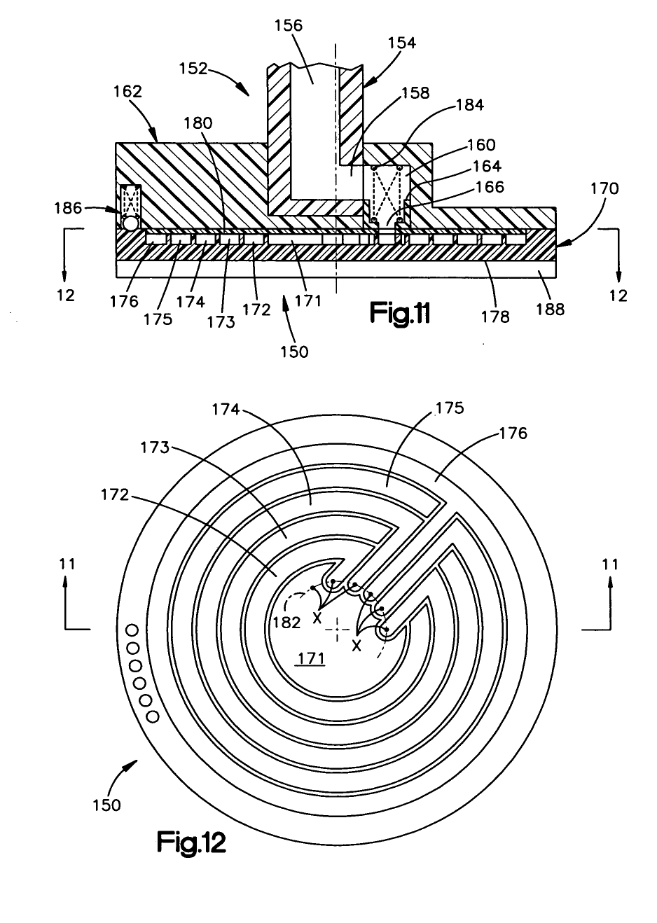

FIGS. 11 and 12 illustrate schematically a showerhead 150 in accordance with another embodiment of the invention. The showerhead 150 is an adjustable showerhead, that is, one that can be manually adjusted to provide several different spray patterns.

The showerhead 150 has an inlet assembly 152 that is designed to be fixed to a shower arm (not shown). The inlet assembly 152 includes a tubular inlet member 154 that has an axially extending water inlet 156 and a radially extending water outlet 158 on one side. The water outlet 158 extends into a chamber 160 in a disc-shaped outer member 162. The outer member 162 is fixed to the inlet member 154. The outer member 162 may be formed as one piece with the inlet member 154.

The chamber 160 is at only one circumferential location of the inlet assembly 152, and does not extend circumferentially around the inlet member 154. Thus, the chamber 160 does not extend for the full width (area) of the showerhead 150, nor for even 50% of the width of the showerhead. Located in the chamber 160 is a U-cup 164, which is a seal member (made from rubber or a rubber-like material, for example) that has an outlet opening 166.

A logic plate 170 is supported for rotation relative to the inlet assembly 152 about a central axis 168 of the showerhead 150. The logic plate 170 has a plurality of waterways of differing configurations. The logic plate illustrated in FIGS. 11 and 12 has six waterways, labeled with the reference numbers 171-176. The waterways 171-176 are individual, separate passages or chambers through which water can flow. The waterways 171-176 are bounded by a front wall 178 and a back wall 180.

Each one of the waterways 171-176 has a respective inlet area indicated in FIG. 12 by a respective letter “X”. The inlet areas X are spaced apart circumferentially in a circular arc 182 centered on the axis 168. The radial distance between the axis 168 and the arc 182 is the same as the radial distance between the axis and the outlet opening 166 in the U-cup 164. The U-cup 164 is pressed downward (as viewed in FIG. 11) by a spring 184 into engagement with the logic plate 170, at a location along the arc 182.

The location and configuration of the logic plate 170 are such that the outlet opening 166 in the U-cup 164 aligns with a selected one of the six inlets X of the logic plate, depending on the rotational position of the logic plate relative to the inlet assembly 152. Thus, the logic plate 170 is rotatable between six different positions, at which water can flow from the inlet assembly 152 to the logic plate. A detent assembly 186 on the opposite circumferential side of the inlet assembly 152 helps to hold the logic plate 170 in the selected position. A front cover shown schematically at 188 covers the logic plate 170 and may provide nozzles, water outlets, a decorative face plate, etc.

When the showerhead 150 is pressurized, water flows into the inlet assembly 152 and through the inlet passage 156 into the chamber 160. Water flows from the chamber 160 through the outlet opening 166 of the U-cup 164 and into the particular selected inlet X of the logic plate 170 that is aligned with the U-cup. The water then flows into the entire one of the waterways 161-166 that is associated with that inlet X.

In this manner, only the selected one of the waterways 161-166 is pressurized, and not the entire showerhead 150 or the entire logic plate 170. In addition, there is no full-width water chamber that is pressurized, at the level of the logic plate 170 or at a level above (upstream of) the logic plate. Therefore, the surface area (width) of the showerhead 150 that is exposed to the pressure of water is strictly limited, as in the preceding embodiments.

It should be understood that the invention is applicable to showerheads of constructions differing from that shown in the drawings. For example, a showerhead in accordance with the invention may includes waterways that are formed on front and back covers, with no separate “base” between them.

1. A showerhead having at least one waterway that contains water when said showerhead is pressurized and at least one cavity adjacent said at least one waterway that does not contain water when said showerhead is pressurized thereby to limit the surface area of said showerhead that is exposed to water pressure.

2. A showerhead as set forth in claim 1 including a front cover and a back cover that are cosmetic and that are not substantially exposed to the pressure of water in said showerhead.

3. A showerhead as set forth in claim 1 wherein said at least one waterway includes a central water receiving chamber, an outer peripheral passage, and a plurality of intermediate passages extending between said central chamber and said outer peripheral passage.

4. A showerhead as set forth in claim 3 wherein said outer peripheral passage has an annular configuration and said intermediate passages extend generally radially in said showerhead.

5. A showerhead as set forth in claim 1 wherein said at least one waterway is formed in a structural unit located behind a front cover of said showerhead.

6. A showerhead as set forth in claim 5 wherein said front cover is releasably secured to said structural unit without screws.

7. A showerhead as set forth in claim 5 wherein said structural unit includes a front piece and a back piece that are secured together to form said structural unit having said at least one waterway.

8. A showerhead as set forth in claim 1 wherein said at least one waterway covers no more than about 10% to about 90% of the front surface area of said showerhead.

8a. A showerhead as set forth in claim 1 wherein said at least one waterway covers no more than about 10% of the front surface area of said showerhead.

8b. A showerhead as set forth in claim 1 wherein said at least one waterway covers no more than about 35% of the front surface area of said showerhead.

9. A showerhead as set forth in claim 1 that is not adjustable to different spray patterns and that does not have a full width water chamber.

10. A showerhead as set forth in claim 1 that is adjustable to different spray patterns and that does not have a full width water chamber.

11. A showerhead comprising:
a water supply assembly;
a base connected with said water supply assembly, said base having a front wall with a plurality of water outlets, said base having a plurality of waterways for directing water from said water supply assembly to said water outlets, said base having a plurality of cavities between said waterways that are not pressurized with water when said showerhead is operated; and
a front cover releasably supported on said base, said front cover having a plurality of openings through which water from said water outlets of said base flows, said front cover not being pressurized with water when said showerhead is operated.

12. A showerhead as set forth in claim 11 wherein said front cover is releasably supported on said base without any screws.

13. A showerhead as set forth in claim 12 wherein said front cover is releasably supported on said base by a plurality of snaps.

14. A showerhead as set forth in claim 11 wherein said base comprises a front piece and a back piece that are joined to each other to form said base, said front piece having said front wall of said base.

15. A showerhead as set forth in claim 11 that is not adjustable to different spray patterns and that does not have a full width water chamber.

16. A showerhead as set forth in claim 11 that is adjustable to different spray patterns and that does not have a full width water chamber.

17. A non-adjustable showerhead including a structural unit having waterways that limit the surface area of said structural unit that is exposed to water pressure thereby limiting the force on said structural unit, said showerhead also including a front cover that carries substantially no water pressure.

18. A showerhead as set forth in claim 17 including a back cover that carries substantially no water pressure.

19. A showerhead as set forth in claim 17 wherein said front cover is releasably secured to said structural unit without screws.

20. A showerhead as set forth in claim 17 wherein said structural unit includes a back wall, a front wall, and a plurality of wall portions defining said waterways between said back wall and said front wall and also defining a plurality of cavities between said waterways, a first part of said front wall overlying said waterways and a second part of said front wall overlying said cavities, said first part of said front wall having a plurality of water outlets for directing water out of said showerhead, said second part of said front wall being free of water outlets.

21. A showerhead as set forth in claim 20 wherein said first part of said front wall has a surface area that is no more than about 35% of the combined surface area of said first and second parts of said front wall.

22. A showerhead as set forth in claim 20 wherein said structural unit has a plurality of nozzles for directing water out of said water chamber, no more than about 40% percent of the front surface area of said structural unit being exposed to the pressure of water in said water chamber.

23. A showerhead as set forth in claim 17 wherein said structural unit has a generally circular configuration with a central water-receiving chamber and a plurality of waterways extending radially outward from said chamber.

24. A showerhead as set forth in claim 17 that is not adjustable to different spray patterns and that does not have a full width water chamber.

25. A showerhead as set forth in claim 17 that is adjustable to different spray patterns and that does not have a full width water chamber.

26. A showerhead having at least one waterway that contains water when said showerhead is pressurized and that does not have a full width water chamber thereby to limit the force of water pressure on said showerhead when said showerhead is exposed to water pressure, said showerhead having a plurality of nozzles that form a spray envelope of said showerhead.

27. A showerhead as set forth in claim 26 having an outer peripheral waterway that extends around the outer perimeter of said spray envelope.

28. A showerhead as set forth in claim 27 having a plurality of intermediate waterways that extend between a water receiving chamber and said outer peripheral waterway.

29. A showerhead as set forth in claim 26 wherein said showerhead does not have a full width water chamber that extends across more than about 50% of the surface width of said showerhead.

30. A showerhead having a plurality of waterways that contain water when said showerhead is pressurized, said showerhead having a plurality of nozzles for directing water from said waterways to form a spray envelope of said showerhead, said plurality of waterways including a central water chamber, an outer peripheral waterway that extends around the outer perimeter of said spray envelope, and a plurality of intermediate waterways extending between said central water chamber and said outer peripheral waterway.

31. A showerhead as set forth in claim 31 having a plurality of open spaces between said intermediate waterways that do not contain water when said showerhead is pressurized thereby to limit the area of said showerhead that is exposed to water pressure.

32. A showerhead as set forth in claim 30 wherein said open spaces are bounded by front and back walls.

33. A showerhead as set forth in claim 30 wherein said waterways cover a surface area that is substantially less than the area of the spray envelope of said showerhead.

34. A showerhead as set forth in claim 3 wherein said waterways cover a surface area that is at least about 50% less than the area of the spray envelope of said showerhead.
